(19) United States
(12) Patent Application Publication
(10) Pub. No.: US 2006/0155525 A1
(43) Pub. Date: Jul. 13, 2006

(54) System and method for improved software simulation using a plurality of simulator checkpoints

(76) Inventors: Maximino Aguilar JR., Austin, TX (US); Patrick Joseph Bohrer, Cedar Park, TX (US); James Michael Stafford, Liberty Hill, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/032,182

(22) Filed: Jan. 10, 2005

(51) Int. Cl. G06F 9/455

(52) U.S. Cl. 703/26

(57) ABSTRACT

A system and method is provided to improve software simulation. A software emulator is used in conjunction with a hardware simulator. A special snapshot instruction is included in the software code that is emulated. When the snapshot instruction is encountered, values such as register, memory, and program stack values, are stored creating an initial snapshot. Code continues to be emulated and, when the next snapshot instruction is encountered, the values are written to create a second snapshot. The initial values are used to set an initial state in a hardware model that is simulated on a hardware simulator. The results of the hardware simulation are compared to the second snapshot to uncover software errors and/or hardware errors so that the software can be modified or the hardware design can be modified. Multiple sets of snapshots can be taken to analyze multiple sections of the software program.

### BACKGROUND OF THE INVENTION

1. Technical Field

The present invention relates in general to a system and method for simulating software. More particularly, the present invention relates to a system and method for using software emulation in conjunction with hardware simulation to yield accurate yet expeditious results.

2. Description of the Related Art

Software emulation and hardware simulation are two approaches that developers used to test hardware that is being designed as well as software that is being developed to run on the new hardware. Developing software for hardware that does not yet exist poses significant challenges.

One approach to this challenge is using a hardware simulator to simulate the actual performance of the hardware design. The hardware is designed and coded into a design description language. One such language is “VHDL” which stands for VHSIC Hardware Description Language (with VHSIC standing for Very High Speed Integrated Circuit). VHDL was developed under guidelines from the U.S. Department of Defense and was adopted as IEEE Standard 1076. VHDL is used by electronic designers, such as a integrated circuit designer, to describe and simulate microchips (processors) and systems before the processors and systems are fabricated. VHDL can be used to model a digital system at many levels of abstraction ranging from the algorithmic level to the gate level. Obviously, including more details in the VHDL design leads to a more accurate representation of the hardware design. Other hardware description languages exist, such as Verilog which is an industry-accepted standard language used by electronic designers to describe and design chips and systems prior to fabrication. The design of a system, chip, or other electronic component is referred to as a “model” of the hardware.

The model is simulated using both specialized programs as well as specialized hardware that replicates how the design encoded in the model will perform in terms of both timing and results. In a processor design, the model includes logic for virtually all the components of the processor, such as registers, adders, loaders, and the like. Simulating a model involves loading the model on a simulator, loading a test case (such as a set of instructions) into the model, and simulating the execution of the test case. Because of the complexity and enormous number of transistors in modern processors, the model can be quite large and simulating the model can be extremely slow. While software, such as a base operating system, could be loaded as a test case and simulated, the time needed to complete the simulation, even on a very fast hardware-based simulator, is usually prohibitive.

Another approach to this challenge is using an emulator that imitates the function of the hardware that is being designed. This approach is much faster than the hardware simulation approach. After an emulator is written, the software, such as the operating system, is emulated by emulator in order to test. The emulator is written to imitate the function of the hardware so that the emulator accepts the same data, executes the same program instructions, and achieves the same results as the hardware being designed. While emulators typically are not able to run the software nearly as fast as the software is expected to run on the hardware, emulation allows the programmer to uncover problems and bugs in the software before the hardware is built. One challenge of using an emulator, however, is that the emulator does not simulate the hardware that is being designed but rather imitates the functions that the hardware is supposed to provide. In order to provide faster results, the emulator does not include many hardware structures other than basic program-accessible structures such as registers. In addition, the emulator is generally incapable of identifying timing problems with the hardware.

What is needed, therefore, is a system and method that takes advantage of an emulators speed, yet uses the accuracy and timing results from a hardware simulator to test critical sections. What is further needed is a system and method that compares results from both simulating and emulating a set of instructions to identify and isolate problems in both the hardware and software design.

### SUMMARY

It has been discovered that the aforementioned challenges are resolved using a system and method that uses the speed of a software emulator coupled with the accuracy of a hardware simulator to test sections of software code. The software is emulated on a software emulator until the beginning of a section of code that is of interest. An initial “snapshot” is taken. During a snapshot the register values, memory values, program stack values, and program counter that are currently stored in the emulator are retrieved and stored. Software emulation continues to a second “snapshot” location where the register, memory, program stack, and program counter values are again retrieved and stored to a second location, such as a data file.

The hardware model is loaded in the hardware simulator and the values retrieved during the initial snapshot are loaded into the model. The hardware simulator then simulates the hardware using the first snapshot as a starting point.

Hardware simulation continues until the simulator reaches the same breakpoint matching the point at which the second snapshot was taken. In essence, from the initial snapshot to the second snapshot the same instructions and processing should have occurred in both the software emulator as well as the hardware simulator. The hardware state existing in the hardware simulator (i.e., the register values, memory values, program stack, program counter, etc.) at the time the simulation was halted (at the breakpoint) are dumped to another file.

A comparison is made between the expected results captured in the second snapshot and the actual (simulated) states that resulted from running the same program segment on the hardware simulator. This comparison may reveal software and/or hardware design flaws which are addressed by the software developers and hardware designers. The developers may modify the software code and the hardware designers may modify the hardware design which results in a modified VHDL model of the hardware. The tests can then be rerun to determine if there are still design flaws in the software/hardware.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing results from a functional simulation being used to seed a hardware model with an initial state and an analysis performed using the hardware simulation results and the functional simulation results;

FIG. 2 shows high level flowcharts of steps that occur during functional simulation, hardware simulation, and steps taken to compare and analyze the results;

FIG. 3 is a flowchart showing steps taken during functional simulation;

FIG. 4 is a flowchart showing steps taken during hardware simulation; and

FIG. 5 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

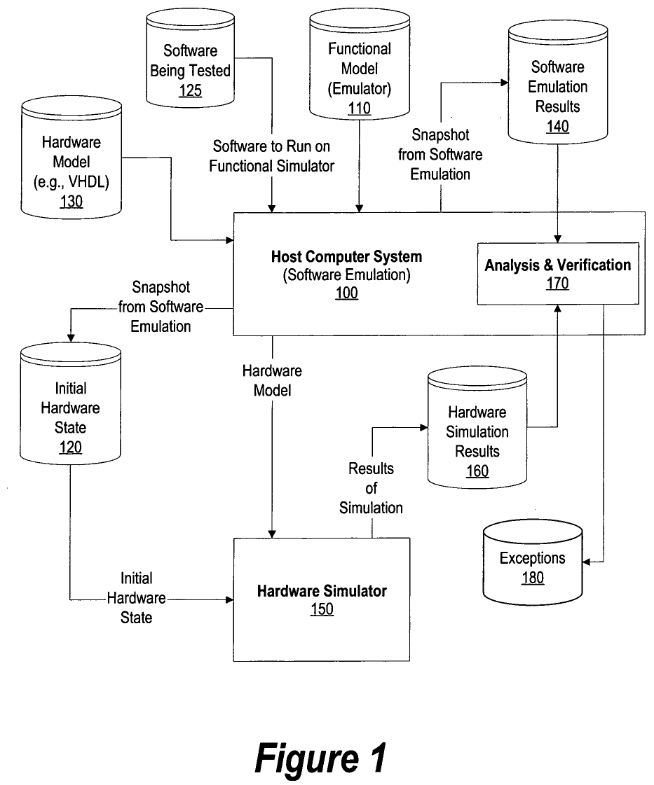

FIG. 1 is a diagram showing results from a functional simulation being used to seed a hardware model with an initial state and an analysis performed using the hardware simulation results and the functional simulation results. Host computer system 100 is used to perform functional simulation using functional model 110 of the system. Functional model 110 is a software emulator that emulates software as if it were running on the actual hardware. Host computer system 100 includes an operating system, such as Linux™ or IBM's AIX™, that has been slightly modified to perform a “snapshot” function when requested in the software that is being tested. Software emulator 110 is run by the operating system that controls host computer system 100.

The software that is being developed and tested (125) is loaded and run on the software emulator. Software 125 includes “snapshot” breakpoint instructions that, when encountered, cause the emulator and operating system to write the current state of the software emulation to a disk file. The initial, or first, snapshot that is encountered is used for setting the initial hardware state (120) in hardware simulator 150. Software emulation continues to the second breakpoint, which causes the emulator and operating system to write software emulation results 140 to a disk file.

Turning now to hardware simulation, a model of the hardware 130, coded in a hardware description language, such as VHDL, is loaded into hardware simulator 150. The initial snapshot from the software emulation (120) is then used to set the initial hardware state of the model that has been loaded in the simulator. The initial hardware state includes the values in program-accessible components, such as registers, memory, the program stack, and the program counter. Hardware simulator 150, now loaded with both the model of the hardware design under test (DUT) along with the initial hardware settings, is initiated to begin running a simulation of the hardware model using the values set in initial hardware state 120. The simulation is eventually halted after simulating as many clock cycles as needed. The point at which the simulation is halted is the same point (i.e., when a particular instruction is reached or when a particular condition occurs) as the breakpoint resulting in the second snapshot (software emulation results 140) from the software emulator. Because both software emulation results 140 and hardware emulation results 160 were recorded when the same instruction or condition occurred, emulation results 140 should be equivalent to simulation results 160. One of skill in the art will understand that simulation results 160 include information about the hardware, such as gate and latch settings, that are not emulated in the software emulator and, therefore, this information will not be in the software emulation results. However, resultant values such as register values, memory settings, and the like, will result from both the software emulation as well as the hardware simulation.

A process on host computer system 100 performs analysis and verification 170 by comparing software emulation results 140 with hardware simulation results 160. If the results are the same, the programmer or designer has a higher degree of confidence that the tested code (the segment between the initial snapshot 120 and second snapshot 140) will perform as expected on the real hardware once the real hardware has been built. Because hardware simulation takes much longer to perform than software emulation, it is likely that the users (software developers, hardware designers, etc.) will focus on critical sections of code. These critical sections may be time-critical sections where the user wants to ascertain whether timing constraints of the hardware, as embodied in hardware model 130, will operate as expected. For example, if the software instructs the hardware to load data into a register and then the software immediately begins using the register value, the analysis and verification step 170 would ascertain whether the data was loaded in time to be used. Exceptions (i.e., unexpected values) are written to exceptions data file 180 for further hands-on analysis by the users. The software emulator would likely assume that the data was loaded in time, while the hardware simulator would, based upon the simulation, reveal whether the data was retrieved in time or whether the instruction that used the register (such as an “add” instruction) was not able to use the loaded value because it had yet to be loaded by the hardware. This situation would lead to different results from the software emulation and hardware simulation with these results being written to exceptions data file 180. For example, the software instructions may call for a value to be loaded from a memory address to a particular register and this value used to perform an addition (“add”) instruction. At the end of the snapshot, the added (resulting) value should be in another register. When comparing emulation results 140 with simulation results 120, if these values are different it may likely indicate that the value had not yet been fully loaded into the register before the add instruction took place. This difference may indicate a flaw in the hardware design with memory latency being greater than expected, or this difference may be expected by the hardware designers and the software developers, such as a compiler developer, needs to include or change instructions so that processing waits until the register has been properly loaded with the memory value before using the register in the addition instruction.

The users of the system can set multiple sets of snapshots (with each set of snapshots including an “initial” snapshot (120) used to set the initial hardware state and a resulting snapshot (140). A separate set of exceptions is written for each set of snapshots. In this manner, multiple critical code segments can be analyzed faster than running all of the code through the hardware simulator.

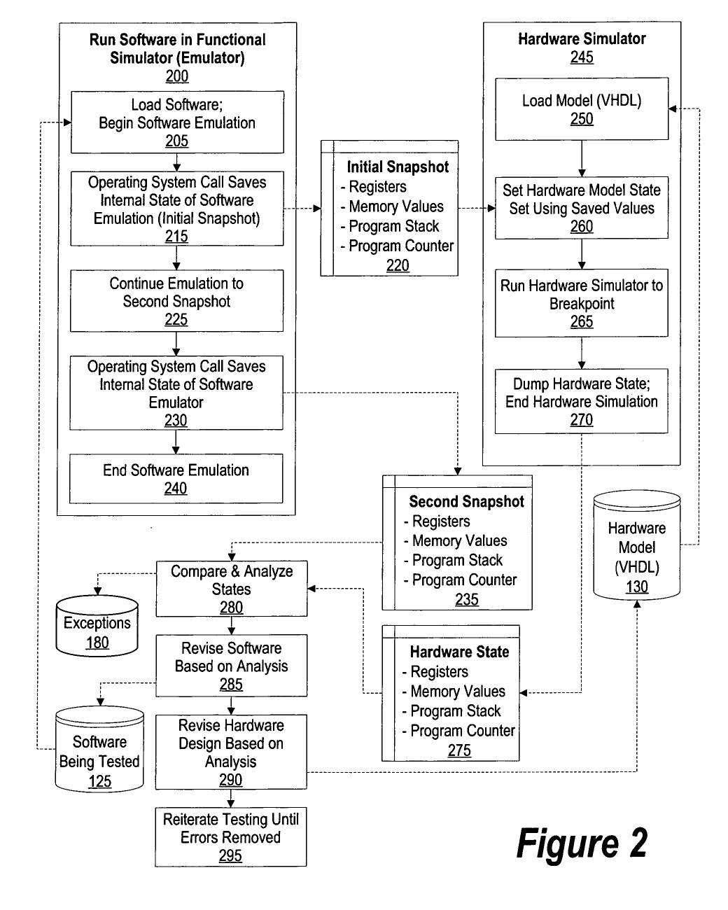

FIG. 2 shows high level flowcharts of steps that occur during functional simulation, hardware simulation, and steps taken to compare and analyze the results. Flowchart 200 shows the steps taken during software emulation, while flowchart 245 shows the steps taken during hardware simulation. Software emulation 200 commences at step 205 with software 125 being loaded into the software emulator and emulation of the software commencing. At a point in the software (i.e., where a critical segment of code or other code section of interest starts), an operating system call saves the internal state of the software emulator (step 215). Step 215 saves the internal state as initial snapshot 220. Initial (first) snapshot 220 includes software-accessible constructs and their respective values. Such things as registers and their values, memory values, program stack values, and the program counter value is saved to initial snapshot 220. At step 225, software emulation continues until another operating system call in the software that is being emulated directs the operating system and emulator to create another snapshot, at step 230. At step 230, second snapshot 235 is taken the same way that the initial snapshot was taken. Now, however, the values of the registers, memory areas, etc., are the values that exist at the time that the second snapshot was taken. For example, if a register was being used as a counter and its value was 4 in the initial snapshot and its value was 10 in the second snapshot, then the counter was incremented six times between the initial snapshot and second snapshot. Software emulation processing then ends at 240.

Turning to hardware simulation processing, hardware simulation commences at 245 whereupon, at step 250, the model of the hardware (130), described in a hardware description language such as VHDL, is loaded into the hardware simulator. At step 260, the state of the hardware model that has been loaded into the hardware simulator is set using the values saved to initial snapshot 220 during software emulation. The hardware simulation commences with after the initial snapshot values have been loaded into the simulator and continues until a breakpoint is reached (step 265). The breakpoint coincides with the point at which second snapshot 235 was taken. For example, during software emulation the second snapshot may have been taken when a particular register, such as a counter, reached a particular value. In the hardware simulator, when the same register reaches the same value, then, at step 270, the hardware simulation is halted and the hardware state (register values, memory values, program stack and counter values, as well as latch and gate settings) are written to hardware state data file 275.

After software emulation and hardware simulation have completed, second snapshot 235 is compared and analyzed with hardware state 275 (step 280). Results or settings that do not match are written to exceptions data store 180. Software developers use the results, such as exceptions 180, to modify the software. For example, in developing a compiler it may be discovered that a value is not arriving at a register as quickly as anticipated, causing incorrect values to be used and an error in the resulting code when executed on the hardware simulator. The software developer can take this information and modify the compiler so that it waits for the data to arrive at the register. Step 285 shows the software developer revising software 125 based upon the analysis that was performed in step 280. As shown, the process is recursive with the (now modified) software being used once again during software emulation to generate the initial snapshot and the second snapshot, with the initial snapshot being used to feed starting values in the hardware simulator and the second snapshot being used to compare and analyze the data resulting from the hardware simulation.

Similar to the software developers, the hardware designers can also use the analysis to revise the hardware design (step 290). For example, if a value is unable to be loaded to a particular register or memory location, it may indicate that the hardware is not working as expected. The design of the hardware can be changed in hardware model 130 and the process reiterated to perform the simulation with an updated hardware model. As shown in step 295, the testing and modification of the software and the hardware model can be reiterated until they have been removed.

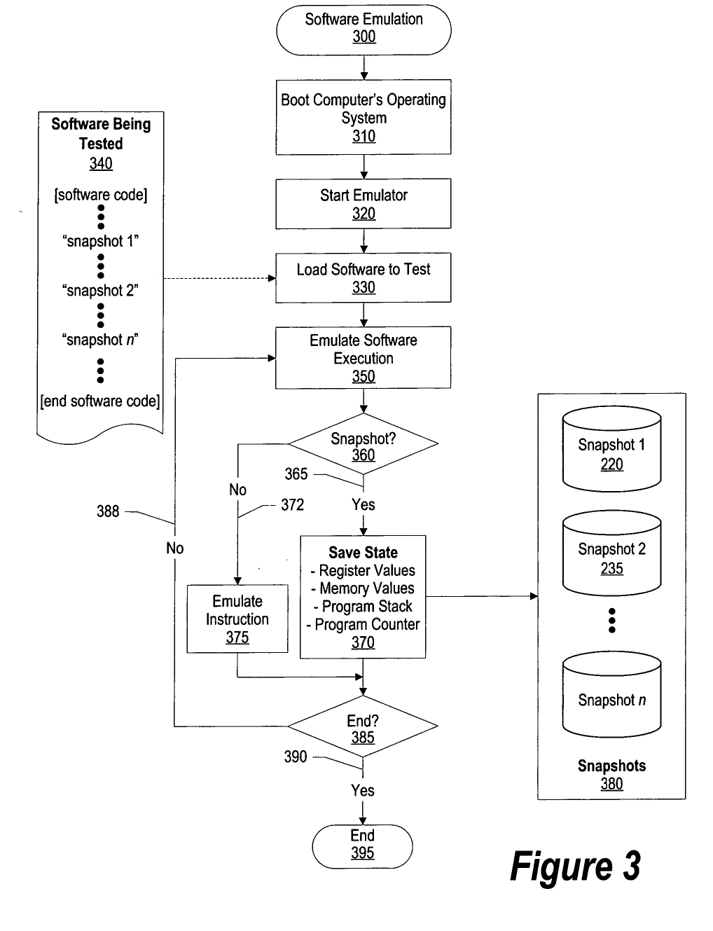

FIG. 3 is a flowchart showing steps taken during functional simulation. Processing commences at 300 whereupon, at step 310, the host computer's operating system is booted. At step 320, the emulator is started, and at step 330, software 340 is loaded in order to run (test) on the software emulator. Software 340 includes software code as well as special “snapshot” instructions. These-snapshot instructions are not actually executed by the emulator, but rather trigger the emulator and operating system to write the value of constructs, such as registers and memory, to a disk file.

At step 350, software emulation commences with the emulator imitating the hardware environment that is being designed. A determination is made as to whether a “snapshot” instruction has been encountered (decision 360). If a snapshot instruction has been encountered, decision 360 branches to “yes” branch 365 whereupon, at step 370, the operating system saves the current state of the software emulation, including the register values, the memory values, the program stack, and the current program counter. The snapshot is written to snapshots data area 380, which is a nonvolatile data area, such as a hard drive or a directory within a drive. Multiple sets of snapshots can be taken, each having an initial (first) snapshot and a second snapshot. For example, if a program has six critical sections of code that the developer wants to test, an initial snapshot instruction would be included in software 340 at the beginning of each critical section and a second snapshot instruction would be included in software 340 at the end of each critical section. In this manner, the first snapshot would be the initial snapshot for the first critical section, the second snapshot would be the second snapshot for the first critical section, the third snapshot would be the initial snapshot for the second critical section, the fourth snapshot would be the second snapshot for the second critical section, the fifth snapshot would be the initial snapshot for the third critical section, and the sixth snapshot would be the second snapshot for the third critical section. Any of the “initial” snapshots could then be used to supply starting values for the initial hardware state, and the “second” snapshot corresponding to the initial snapshot would be used to analyze and compare the data resulting from the hardware simulation.

Returning to decision 360, if the instruction is not a snapshot instruction, decision 360 branches to “no” branch 372 whereupon the instruction is emulated at step 375. A determination is made as to whether the end of the software that is being emulated has been reached (decision 385). If the end has not been reached, decision 385 branches to “no” branch 388 which loops back to emulate the next instruction. This looping continues until the end of the software being tested has been reached, at which point decision 385 branches to “yes” branch 390 and processing ends at 395.

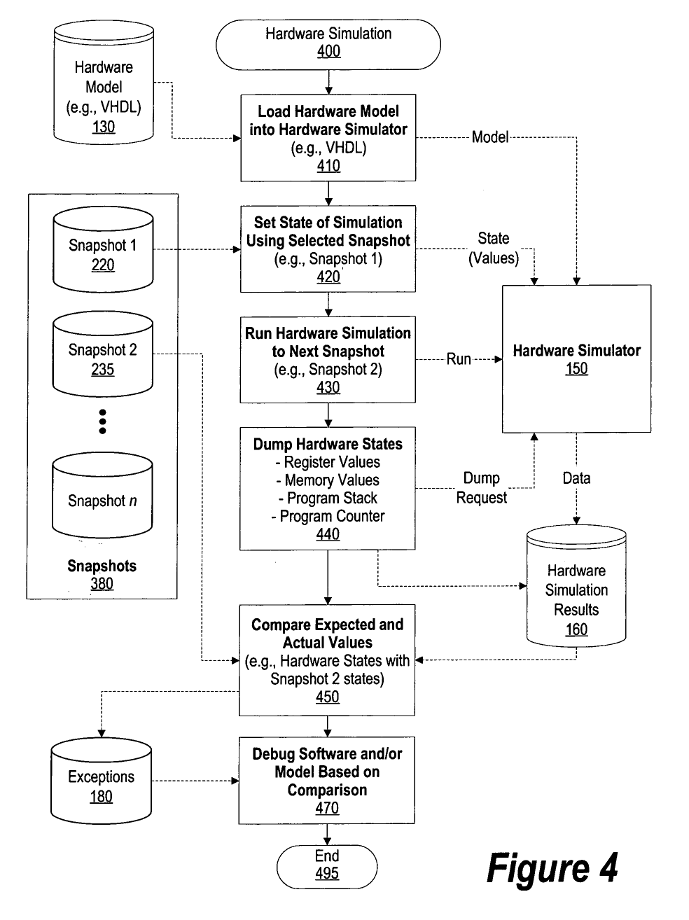

FIG. 4 is a flowchart showing steps taken during hardware simulation. Processing commences at 400 whereupon, at step 410, hardware model 130 is loaded into hardware simulator 150. At step 420, a snapshot is selected from snapshots data area 380 and the selected snapshot is used to set the initial hardware states of the model that has been loaded into the hardware simulator. At step 430, the hardware simulation is run until a breakpoint occurs. The breakpoint coincides with the point at which the second snapshot was taken. When the hardware simulation reaches the breakpoint, at step 440, the hardware states that exist in hardware simulator after running the simulation are requested and these values are written to hardware simulation results data file 160. Results includes register values, memory values, program stack and counter values, as well as latch and gate settings.

At step 450, the “expected” values achieved through software emulation are compared to the “actual” values resulting from hardware simulation. The second snapshot that corresponds to the initial snapshot is used and compared with hardware simulation results 160. Errors or discrepancies between the expected and actual values are written to exceptions data file 180. At step 470, the software is modified if errors are found with the software or if the problem can more easily be circumvented with a software change rather than a hardware design change. If the hardware design includes flaws that were uncovered by comparing the expected and actual values, then the hardware design is changed (modifying hardware model 130) for reuse in further hardware simulations.

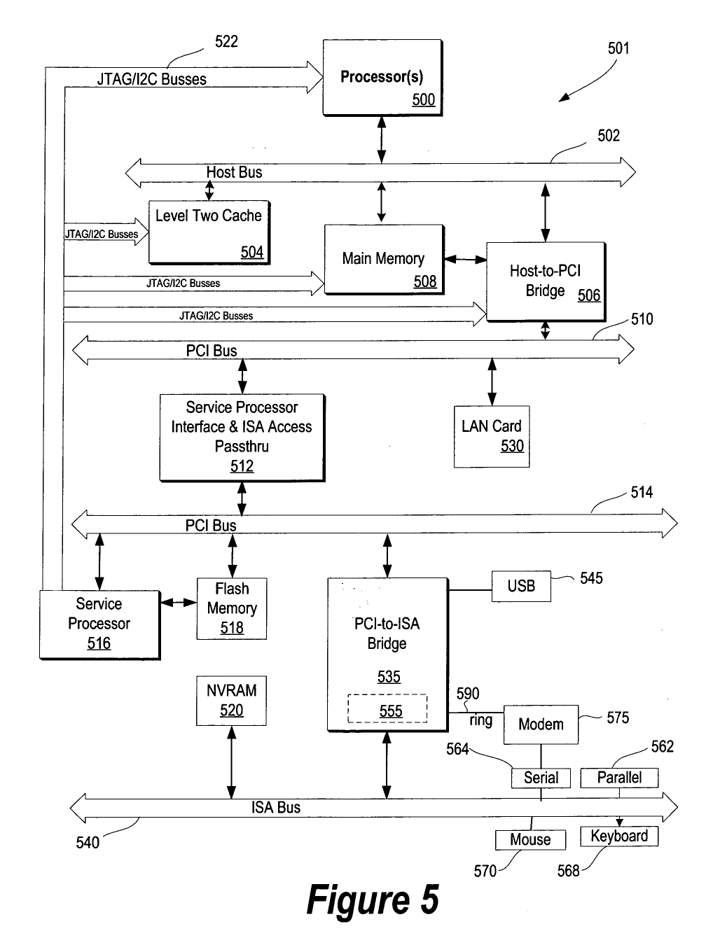

FIG. 5 illustrates information handling system 501, which is a simplified example of a computer system capable of performing the computing operations described herein. Computer system 501 includes processor 500, which is coupled to host bus 502. A level two (L2) cache memory 504 is also coupled to host bus 502. Host-to-PCI bridge 506 is coupled to main memory 508, includes cache memory and main memory control functions, and provides bus control to handle transfers among PCI bus 510, processor 500, L2 cache 504, main memory 508, and host bus 502. Main memory 508 is coupled to Host-to-PCI bridge 506 as well as host bus 502. Devices used solely by host processor(s) 500, such as LAN card 530, are coupled to PCI bus 510. Service Processor Interface and ISA Access Pass-through 512 provides an interface between PCI bus 510 and PCI bus 514. In this manner, PCI bus 514 is insulated from PCI bus 510. Devices, such as flash memory 518, are coupled to PCI bus 514. In one implementation, flash memory 518 includes BIOS code that incorporates the necessary processor executable code for a variety of low-level system functions and system boot functions.

PCI bus 514 provides an interface for a variety of devices that are shared by host processor(s) 500 and Service Processor 516 including, for example, flash memory 518. PCI-to-ISA bridge 535 provides bus control to handle transfers between PCI bus 514 and ISA bus 540, universal serial bus (USB) functionality 545, power management functionality 555, and can include other functional elements not shown, such as a real-time clock (RTC), DMA control, interrupt support, and system management bus support. Nonvolatile RAM 520 is attached to ISA Bus 540. Service Processor 516 includes JTAG and I2C busses 522 for communication with processor(s) 500 during initialization steps. JTAG/I2C busses 522 are also coupled to L2 cache 504, Host-to-PCI bridge 506, and main memory 508 providing a communications path between the processor, the Service Processor, the L2 cache, the Host-to-PCI bridge, and the main memory. Service Processor 516 also has access to system power resources for powering down information handling device 501.

Peripheral devices and input/output (I/O) devices can be attached to various interfaces (e.g., parallel interface 562, serial interface 564, keyboard interface 568, and mouse interface 570 coupled to ISA bus 540. Alternatively, many I/O devices can be accommodated by a super I/O controller (not shown) attached to ISA bus 540.

In order to attach computer system 501 to another computer system to copy files over a network, LAN card 530 is coupled to PCI bus 510. Similarly, to connect computer system 501 to an ISP to connect to the Internet using a telephone line connection, modem 575 is connected to serial port 564 and PCI-to-ISA Bridge 535.

While the computer system described in FIG. 5 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method comprising:
emulating a plurality of instructions on a software emulator;
writing a first set of emulator values to an initial snapshot data file;
writing a second set of emulator values to a second snapshot data file;
loading a hardware model into a hardware simulator;
setting a state of the hardware model according to the first set of emulator values;
simulating the hardware model after setting the state;
retrieving a resulting hardware state after the simulation; and
comparing the resulting hardware state to the second set of emulator values.

2. The method of claim 1 wherein the writing of the first and second sets of emulator values are each performed when a snapshot instruction is encountered in the plurality of instructions.

3. The method of claim 1 further comprising:
halting the hardware simulation at a point equivalent to the writing of the second set of emulator values.

4. The method of claim 1 wherein the emulator values are selected from a group consisting of register values, memory values, program stack values, and a program counter value.

5. The method of claim 1 further comprising:
identifying, based upon the comparison, an error in the plurality of instructions; and
modifying one or more of the instructions included in the plurality of instructions in order to correct the identified error.

6. The method of claim 1 further comprising:
identifying, based upon the comparison, an error in the hardware model; and
modifying the hardware model in order to correct the identified error.

7. The method of claim 1 wherein the hardware model is in written in VHDL.

8. The method of claim 1 further comprising:
writing a plurality of first and second sets of emulator values based upon encountering a plurality of corresponding first and second snapshot instructions in the plurality of instructions, wherein each first set of emulator values corresponds to at least one second set of emulator values;
selecting one of the plurality of first sets of emulator values;
setting the state of the hardware model to the emulator values corresponding to the selected first set; and
comparing the resulting hardware state to the second set of emulator values that corresponds to the selected first set.

9. The method of claim 1 wherein the hardware simulator is a specialized information handling system designed to simulate hardware designs.

10. The method of claim 1 further comprising:
identifying one or more exceptions based upon the comparison; and
writing the exceptions to an exceptions data file.

11. An information handling system comprising:
one or more processors;
memory accessible by the processors;
a nonvolatile storage device accessible from one or more of the processors; and
a simulation tool for testing software that includes a plurality of instructions on a hardware design, the simulation tool including:
means for emulating the plurality of instructions on a software emulator;
means for writing a first set of emulator values to an initial snapshot data file;
means for writing a second set of emulator values to a second snapshot data file;
means for loading a hardware model corresponding to the hardware design into a hardware simulator;
means for setting a state of the hardware model according to the first set of emulator values;
means for simulating the hardware model after setting the state;
means for retrieving a resulting hardware state after the simulation; and
means for comparing the resulting hardware state to the second set of emulator values.

12. The information handling system of claim 11 wherein the means for writing of the first and second sets of emulator values are each performed when a snapshot instruction is encountered in the plurality of instructions.

13. The information handling system of claim 11 further comprising:
means for halting the hardware simulation at a point equivalent to the writing of the second set of emulator values.

14. The information handling system of claim 11 wherein the emulator values are selected from a group consisting of register values, memory values, program stack values, and a program counter value.

15. The information handling system of claim 11 further comprising:
means for identifying, based upon the comparison, an error in the plurality of instructions; and
means for modifying one or more of the instructions included in the plurality of instructions in order to correct the identified error.

16. The information handling system of claim 11 further comprising:
means for identifying, based upon the comparison, an error in the hardware model; and
means for modifying the hardware model in order to correct the identified error.

17. The information handling system of claim 11 wherein the hardware model is in written in VHDL.

18. The information handling system of claim 11 further comprising:
means for writing a plurality of first and second sets of emulator values based upon encountering a plurality of corresponding first and second snapshot instructions in the plurality of instructions, wherein each first set of emulator values corresponds to at least one second set of emulator values;
means for selecting one of the plurality of first sets of emulator values;
means for setting the state of the hardware model to the emulator values corresponding to the selected first set; and
means for comparing the resulting hardware state to the second set of emulator values that corresponds to the selected first set.

19. The information handling system of claim 11 wherein the hardware simulator is a specialized information handling system designed to simulate hardware designs.

20. The information handling system of claim 11 further comprising:
means for identifying one or more exceptions based upon the comparison; and
means for writing the exceptions to an exceptions data file.

21. A computer program product stored on a computer operable media, the computer program product comprising:
means for emulating a plurality of instructions on a software emulator;
means for writing a first set of emulator values to an initial snapshot data file;
means for writing a second set of emulator values to a second snapshot data file;
means for loading a hardware model into a hardware simulator;
means for setting a state of the hardware model according to the first set of emulator values;
means for simulating the hardware model after setting the state;
means for retrieving a resulting hardware state after the simulation; and
means for comparing the resulting hardware state to the second set of emulator values.

22. The computer program product of claim 21 wherein the writing of the first and second sets of emulator values are each performed when a snapshot instruction is encountered in the plurality of instructions.

23. The computer program product of claim 21 further comprising:
means for halting the hardware simulation at a point equivalent to the writing of the second set of emulator values.

24. The computer program product of claim 21 wherein the emulator values are selected from a group consisting of register values, memory values, program stack values, and a program counter value.

25. The computer program product of claim 21 further comprising:
means for identifying, based upon the comparison, an error in the plurality of instructions; and
means for modifying one or more of the instructions included in the plurality of instructions in order to correct the identified error.

26. The computer program product of claim 21 further comprising:
means for identifying, based upon the comparison, an error in the hardware model; and
means for modifying the hardware model in order to correct the identified error.

27. The computer program product of claim 21 wherein the hardware model is in written in VHDL.

28. The computer program product of claim 21 further comprising:
means for writing a plurality of first and second sets of emulator values based upon encountering a plurality of corresponding first and second snapshot instructions in the plurality of instructions, wherein each first set of emulator values corresponds to at least one second set of emulator values;
means for selecting one of the plurality of first sets of emulator values;
means for setting the state of the hardware model to the emulator values corresponding to the selected first set; and
means for comparing the resulting hardware state to the second set of emulator values that corresponds to the selected first set.

29. The computer program product of claim 21 wherein the hardware simulator is a specialized information handling system designed to simulate hardware designs.

30. The computer program product of claim 21 further comprising:
means for identifying one or more exceptions based upon the comparison; and
means for writing the exceptions to an exceptions data file.
